(19) United States
(12) Patent Application Publication
(10) Pub. No.: US 2008/0015912 A1
(43) Pub. Date: Jan. 17, 2008

(54) Systems and methods for workforce management

(76) Inventors: Meryl Rosenthal, Hillsdale, NJ (US); Robin Roschke, Yorktown Heights, NY (US)

Correspondence Address: KLEHR , HARRISON ET AL, 260 S. BROAD STREET, PHILADELPHIA, PA, 19102, US

(21) Appl. No.: 11/731,456

(22) Filed: Mar. 30, 2007

Related U.S. Application Data
(60) Provisional application No. 60/787,615, filed on Mar. 30, 2006.

(51) Int. Cl. G06F 9/44

(52) U.S. Cl. 705/7

(57) ABSTRACT

Methods of managing employment between an employer and one or more applicants are provided by a system in which job information pertaining to an employment position that needs to be filled that includes but is not limited to data relating to the flexibility of the employment position is provided so one or more users can access it. A correlation between one or more applicants and the job information is created and reported so that the job may ultimately be filled efficiently and effectively. Preferably, the present invention is implemented in the form of a website, which can be password protected if desired and in certain embodiments requires payment of a subscription fee. Typically, the data relating to flexibility comprises data related to the hours, benefits, schedule and location of the employment position, and preferably the data relating to flexibility is categorized into one or more employment mode categories which most preferably include data relating to acceptable experience levels, time out of the workforce and lifestyle data. The employment mode categories can be self-selected by an applicant from a fixed menu of choices, or may be assigned based upon data inputs. Additionally, employers may use the methods disclosed herein to collect flexibility data concerning the correlation and rate of fulfillment of employment positions and analyzing the data to determine a statistical measure of job flexibility within a single organization. The flexibility data may also be collected for a plurality of organizations and an objective flexibility index can be determined to benchmark an organization against a standard. In certain embodiments, a feature is provided by which an employer may elect to “flex” a position or a user may elect to “flex” themselves.

This application claims priority from Provisional Patent Application No. 60/787,615 filed Mar. 30, 2006.

The present invention relates to methods and related software systems for managing a workforce, and more specifically relates to providing a system for job sharing, job allocation and “flex time” arrangements.

### BACKGROUND OF THE INVENTION

As companies adjust to a more diverse workforce in terms of age, ethnicity, and gender they must adapt to the increasing demand for the next level of work/life balance. Companies face significant challenges as a result of the intensifying workforce crunch. This is driven by the loss of professional working mothers leaving and not returning, Baby Boomers now approaching retirement, “Sandwich Generation” employees facing significant challenges, caring for elder parents and children simultaneously (already costing employers $11-$29 billion annually). The foregoing trends are exacerbated by the increasing portion of childless men and women seeking flexibility in their employment situation and younger workers who view their careers as “mobile.” Combined with an impending labor shortage (i.e., by 2010 there will only be 141 million employees available to fill 151 million jobs) companies should view the mainstream demand for flexibility as an opportunity to attract and retain the “next generation” workforce.

Ultimately, a company's ability to grow and remain competitive is driven by the productivity of its employees. A lack of responsiveness to work/life balance demands will have a staggering impact. A company unprepared for these challenges faces a weakened competitive position due to reduced employee quality as skilled and experienced professionals are replaced by less seasoned employees. A company will also suffer continued erosion of its workforce as younger employee entrants continue to be “conditioned” to leave after two to five years. These gaping holes in corporate employee base will negatively impact the institutional knowledge and experience and as a result the value of the employee base as a corporate asset is diminished.

Finally, a lack of preparedness to integrate a flexible workforce will likely result in unmet diversity goals and as a result companies will fail to grow, motivate, and maintain a diverse workforce and therefore create a diminished perception of their desirability as an employer.

Employers across industry segments have already taken steps to address the changing nature of the workforce. Through diversity and work/life balance programs, companies are offering employees the opportunity to have a viable career while maintaining their personal priorities. Additionally, some companies have begun to “court” older (i.e., 50+) employees as well as “return to work” professionals (e.g., mothers). However, employers lack the ability to reach these underserved employee segments through current recruiting mechanisms. Furthermore, many companies are still in the early stages of their employee effectiveness initiatives and do not fully recognize the potential contributions these segments offer.

Systems have existed for several years that attempt to utilize the power of digital computers, databases, networked communications and the Internet to attack one or more of the problems set forth above. For example, United States Publication No. 20050166070 published Jul. 28, 2005 and entitled “Web based user interface” relates to a web based user interface that enable users to view and control a system running inside a corporate intranet when the user is outside the corporate network. A user interface is provided on a web site so that a user can acquire access to a controller of a system through the Internet. Although this relates to intranet security, scheduling flextime is mentioned.

United States Publication No. 20040064585 published Apr. 1, 2004 and entitled “Predicting and adjusting users' working hours and electronic calendar events” discloses predicting and adjusting future working hours and calendar events for users of electronic calendars. Predictions may be made based on historical calendar data (e.g., a user's scheduled working hours/events and that user's actual working hours/events); based on updates to working hours or events; and/or based on external information. Rules are used in preferred embodiments to indicate the actions that should be taken when a particular condition occurs.

United States Publication No. 20030043266 published Mar. 6, 2003 and entitled “Work data collection method” obtains biological data through observation devices and job titles are recorded on a data-recording device in association with time data that are generated at regular intervals. A data processing computer produces a graph from the data read out from the data-recording device. The observation devices, the data-recording device and the data processing computer are connected to a network, so that a required graph may be produced by processing data at a place remote from the observatory.

U.S. Pat. No. 5,890,133 issued Mar. 30, 1999 and entitled “Method and apparatus for dynamic optimization of business processes managed by a computer system” relates to a method and a device for the dynamic optimization of business processes, the instances of a business process being managed by a workflow management computer system. The system is in particular characterized by collecting, investigating and storing parameters, processing data and result data, and subsequently optimizing business processes on the basis of stored information by identifying a business process instance having propitious result data, modifying the parameters of such an instance and subsequent verification of such modification.

U.S. Pat. No. 5,696,702 issued Dec. 9, 1997 and entitled “Time and work tracker” discloses a method and system for automatically collecting and for analyzing information about time and work performed on a computer includes the following elements: data collector means for monitoring certain portions of a user's computer activity; data collector means for logging into a log file those certain portions of a user's computer activity; data analyzer means for determining, by means of user-defined rules, which portions of those certain portions of a user's computer activity constitutes continuous work activities and how this work should be categorized by project and task with project; and external interface means for building the rules defining work.

There remains however, a long-felt and as of yet unmet need for a comprehensive solution to the problem of facilitating and optimizing an employment relationship by and among employees and employers in a situation or a regime in which job functions and responsibilities are share or allocated in a flexible or non-traditional manner.

### SUMMARY OF THE INVENTION

Accordingly it has now been found that these and other previously unmet needs of the market are satisfied by the present invention, which provides methods of managing employment between an employer and one or more applicants. In accordance with invention job information pertaining to an employment position that needs to be filled that includes but is not limited to data relating to the flexibility of the employment position is provided so one or more users can access it. A correlation between one or more applicants and the job information is created and reported so that the job may ultimately be filled efficiently and effectively. Preferably, the present invention is implemented in the form of a website, which can be password protected if desired and in certain embodiments requires payment of a subscription fee. Typically, the data relating to flexibility comprises data related to the hours, benefits, schedule and location of the employment position, and in certain preferred embodiments, the data relating to flexibility is categorized into one or more employment mode categories which most preferably include data relating to acceptable experience levels, time out of the workforce and lifestyle data. The employment mode categories are self-selected by an applicant from a fixed menu of choices, or may be assigned based upon data inputs. Additionally, employers may use the methods disclosed herein to collect flexibility data concerning the correlation and rate of fulfillment of employment positions and analyzing the data to determine a statistical measure of job flexibility within a single organization. The flexibility data may also be collected for a plurality of organizations and an objective flexibility index can be determined to benchmark an organization against a standard.

In alternate embodiments, the present invention discloses methods of providing flexible employment in an organization to one or more applicants by providing job information pertaining to an employment position that needs to be filled, which includes but is not limited to data relating to the flexibility of the employment position. Access to the job information is provided to one or more potential applicants and a correlation is created between one or more of said applicants and said job information and this correlation is reported so the position can be filled appropriately. This aspect of the present invention may be applied to existing employees of the organization or can be directed to individuals not employed the organization. Additionally certain embodiments of the invention can provide information about flexible employment relevant to one or more of employees and employers, preferably by categorizing the data relating to flexibility into one or more employment mode categories, which most preferably include data relating to acceptable experience levels, time out of the workforce and lifestyle data. In certain embodiments, the employment mode categories are self-selected by an applicant from a fixed menu of choices. Additionally, the present invention may be implemented to collect flexibility data concerning the correlation and rate of fulfillment of employment positions and analyzing the data to determine a statistical measure of job flexibility within a single organization, or may be collected for a plurality of organizations and an objective flexibility index is determined to benchmark an organization against a standard.

In a most preferred embodiment, the present invention provides a website for managing employment between an employer and one or more applicants that includes a system for providing job information pertaining to an employment position that needs to be filled which has data relating to the flexibility of the employment position. This feature is enabled by activating a specific portion of said website to enable the processing of data pertaining to flexibility, and the activation of the flexibility feature may be made by the election of an employer or by the election of an employee. The website of this embodiment will provide access to the job information to one or more potential applicants and provide a system to create and display a correlation between one or more of said applicants and said job information so that a report identifying the applicants and the correlation between the applicants and the job information is generated.

### BRIEF DESCRIPTION OF THE DRAWINGS

FIG. 1 is a screen shot of a website made in accordance with the present invention;

FIG. 2 is a screen shot of the employer portion of a website made in accordance with the present invention; and

FIG. 3 is a screen shot of further details of the employer portion of a website made in accordance with the present invention.

### DETAILED DESCRIPTION OF THE PREFERRED EMBODIMENTS

The present invention provides a mechanism to connect employers offering positions that appeal to those seeking viable careers while maintaining work/life balance. This may include flexible work arrangements with modified schedules and compensation, opportunities for individuals re-entering the workforce, positions that appeal to diverse emerging markets as defined by age, gender and ethnicity. In a preferred embodiment, the present invention serves three distinct communities, namely corporations, sponsors and job seekers. In terms of corporations, employers use the system to establish a top-tier workforce and leadership position as an employer of choice. Employers distinguish themselves by either purchasing a position of prominence as a sponsor, via advertising or similar models and/or may achieve prominence by more objective measures such as participation and benefits realized from surveys, voting, etc. The second group, sponsors, includes service providers that offer products and services targeting market segments to which the system is directed. These entities recognize that job seekers utilizing the system of the present invention represent diverse segments and are in the midst of a life event change. By providing non-employment related “value added” services, job seekers will continue to return to use the resources provided by the disclosed system even after the have completed their search. The final community, job seekers, includes those professionals looking to fulfill their work/life balance, locate key resources and establish networks.

In addition to providing a system by which individuals create a new standard within work/life balance, the present invention takes fullest advantage of online recruiting. Specifically, since the e-business boom there has been a proliferation of websites dedicated to recruiting. Some of these sites are “online only” whereas others have been launched by traditional brick and mortar executive search firms. While each of these websites facilitate job search efforts, the information provided is not always customized to any particular user group, rather it is categorized by geographic region or industry and jobs are listed on multiple boards. While a wide range of sites exists, there are only a few sites that specialize in a particular industry, a particular market segment or offer a unique advantage. Furthermore, these sites have generated a significant increase in the workload for recruiters. Human Resource professionals receive thousands of resumes from candidates who are not qualified and/or geographically desirable. There is a demand for niche websites and a mechanism to better qualify candidates. Additionally, job seekers are demanding more from potential employers; the present invention screens corporations to ensure they have the policies and programs that distinguish them as a family-friendly employer.

The present invention, in a preferred embodiment, comprises a web portal, or a unique on-line marketplace that will connect employers offering flexible work environments with individuals who place a premium on working flexibly and help both master this new way of working. This ‘flexibility’ includes giving employees greater choice and control over how, when, and where they work, and variation in career paths. The portal of the present invention, which is created using standard Internet and website design technologies, is a combination employment resource, learning community, and social/professional networking site. As a result, it will help employers attract, access, and retain these highly valued segments, and bolster their employment brand. Additionally, it will enhance the organizational environment as it relates to flexibility and diversity so that the cultures, systems, work processes and organizational infrastructure can deliver the climate and practices these segments expect.

The present invention may be implemented as an Internet, intranet, or both, and offers a robust set of features to support an employer's recruitment and retention objectives. The details of the programming required to implement the methods set forth herein are well known and within the level of skill in the art of website design and implementation. In general, software implementing the methods disclosed herein will require the ability to accept input from a user and store data, and execute logic functions and queries. As known in the art, there are a wide variety of commercially available programs that can be used for these purposes and, moreover, websites having the attributes herein can also be constructed using readily available tools and programming languages separate and apart from any templates or purchased software. Because the present invention involves both personal and financial information, it is understood that appropriate security safeguards are in place, including but not limited to password protection and user identification. Such security measures also restrict unauthorized use in those embodiments of the present invention in which a license fee, subscription fee or other user fee is charged, either to the job seeker or the corporation seeking to fill a job, or both.

In one embodiment or one portion of a multi-page website, an Internet site accessible by the public includes an Employer Module that enables employers to connect with potential employees and professional peers (such as executives in other companies involved in Human Resources, diversity initiatives, etc.). This module lets the employer master the art of flexibility in terms of employment by assisting with finding, retaining, and engaging diverse talent segments that value flexibility. As a result, the employer gains a reputation as an employer that values flexibility. The Employer Module also permits the employer to evaluate people and the employer's corporate organization to improve ‘matches’ and to assess needs, results and trends.

Certain preferred embodiments of the present invention will also include additional features designed specifically for use by talent acquisition, diversity, talent management, health & wellness and general HR professionals. One such feature is organizational profiles and assessments that provide templates for members to describe their organization's flexibility philosophy and practices on a web portal. The tools help them promote the degree to which they offer flexible employment and enable jobseekers to evaluate a match with their own requirement, these tools permit the employer to gauge how they are faring as it relates to achieving a flex work environment/managing a flex workforce. Assessment tools help organizations evaluate where they are on the spectrum toward becoming fully flexible. Another additional feature is the provision of flexibility tools, templates and resources that assist in the development, implementation and evaluation of flexibility strategies. The tools are designed specifically for a variety of end users, i.e., customized for recruiters, diversity professionals, those charged with training and development, etc. Yet another additional feature is a learning communities and best practice exchanges section which for employers implements information exchanges connecting professionals in human resources, recruiting, diversity, branding, talent management, and health/wellness, as well as managers with peers, to share flexibility challenges, experiences and best practices. In certain embodiments the present invention may also provide research, data, and opinion surveys that permit employers to participate in research, e.g., on trends, and user-friendly data for both to use in negotiating for and/or measuring the success of flexible employment practices. Another additional feature is the inclusion of employer diagnostics, standardized and customized benchmarking data, utilization data and impact reports. A website constructed in accordance with the present invention can also include online offerings tailored to particular market segments, or “employment modes.” These modes represent a candidate's “work intention” and help employers gain insight about candidates.

Finally, it is anticipated that the present invention will serve as an industry standard as to how organizations are evaluated as they make flex available and result in an objective, rules-based “flexibility index” featuring assessment questions geared at determining whether an employer has a fully flexible human capital culture. To do so the index would assess and understand job flexibility to include cultural conditions (expectations, assumptions) and practices that go beyond flexible scheduling arrangements or telecommuting. The system would also quantify and define flexibility to include career flexibility and flexible employment relationships (e.g., project/contracted work), as well as informal or occasional flexibility and assess whether employees, candidates, recruiters, and hiring managers know how to use different types of flexibility, when, under what conditions, and for which individuals.

In certain embodiments or one portion of a multi-page website, an Internet site accessible by the public includes an Employee Module that enables employees to connect with potential employers. With employers that offer a flexible culture and peers who want to become better at working flexibly and thereby master the art of working flexibly to be employed in an organization with a flexible culture. As a result the employee can manage their work schedule and lifestyle with tailored tools and resources, and make informed career decisions.

In preferred embodiments, various features help individuals make informed employment decisions and become more adept at working flexibly, ultimately benefiting the organization they choose. For example, the present invention provides employee and job seeker profiles and assessments, primarily in the form of self-assessments that help candidates clarify their priorities in terms of flexibility and create experience profiles that include non-traditional skills and experience (e.g., community work). Another feature of the employee section are flexibility tools, templates and informational resources that help candidates make informed decisions about the various options for working flexibly and to support their success. Information exchange about what works and what doesn't work help individuals in creating or sustaining a flexible option is another feature implemented in certain embodiments. The present invention also can provide research, data, and survey results to individuals and permit them to participate in research, e.g., on trends, and have access to user-friendly data to help them negotiate for flexible positions and arrangements.

In addition to the present invention providing a public website, components of the site can be licensed and accessed by internal stakeholders within the client's organization either via intranet or extranet. It can supplement and expand a member's intranet content and processes and support the work of such internal stakeholders as those charged with talent acquisition, talent management, diversity, employment branding, organization transformation, health and wellness, and work-life effectiveness. Its use on an intranet can also give current employees greater knowledge about and access to flexible opportunities and resources to help them become more adept at flexibility. Its community/networking functions also make it possible for managers and HR professionals to connect with internal peers and share techniques for managing in a flexible environment. The present invention recognizes the opportunity to establish a market leader position by supporting the increasing corporate and consumer demand for this new, flexible way of working. The present invention has four distinct advantages that enable it to create a new niche in proven markets. First, the system disclosed is a unique talent magnet that applies a unique filter for evaluating jobs and organizations to determine their degree of flexibility and thus creates a new niche in proven on-line markets. This unique filter will attract and retain talent that organizations would not otherwise be able to find and keep. It will help individuals find flexible employers and jobs, and evaluate their needs and the opportunities more effectively. Ultimately, better job matches are be made, and retention is more sustainable. Second, the present invention provides resources for individuals and corporations and thus addresses the needs of varied user audiences individuals and, on the corporate side, those charged with talent acquisition, talent management, diversity, employment branding and health/wellness -- will have a single point of access to best in class resources and information, as well as opportunities to network with peers. Next, using a filter of flexibility allows the present invention to target and attract diverse groups of in-demand talent—women, retirees/mature workers, younger workers, etc. whose common interest in flexibility has not yet been leveraged in the marketplace. Finally, relevant and incremental utilization is achieved by selecting the components of the site that are relevant to their company's strategy and business requirements. Furthermore, while the present invention can be used to attract candidates via the Internet, it can also be used to retain and engage employees by including our content/resources on the employer's intranet or a branded extranet.

As stated previously, the present invention is dedicated to serve as the mechanism to connect employers offering positions that appeal to those seeking viable careers while maintaining work/life balance. This may include flexible work arrangements with modified schedules and compensation, opportunities for individuals re-entering the workforce, positions that appeal to diverse emerging markets as defined by age, gender and ethnicity. The present invention offers companies the opportunity to be market leaders and solidify their position as “employers of choice.” Whether a corporation is already ahead of the pack or is looking to catapult its efforts, the present invention will serve as a key point of differentiation. Companies that participate on the present invention will help reset the workforce standard for the 21^{st} century workforce. These are companies that believe in inclusion, that recognize the value of diversity, and are committed to employee effectiveness via work/life balance. The present invention will qualify participating corporations to ensure that they “walk the talk” and have established a work-life balance friendly environment.

The present invention is distinguished from existing online recruiting services (e.g., Monster.com) because it provides a work/life framework via which Job positions and resources are defined in the context of work/life balance. These opportunities offer either flexible work built in or the positions are with a company that is considered an “employer of choice” and inclusive. The system is also different from a conventional career website because it offers users distinct navigation paths, preferably comprising the “Employment Mode” that represents the type of shift an employee is seeking. From a company perspective, these modes represent distinct talent pools to tap. Job seekers select a profile and search for job postings that are listed within these categories. The “employment modes” each represent the type of shift in employment status an employee is seeking. From a company perspective, these modes represent distinct talent pools to tap. Additionally, in certain embodiments the system contemplated herein will offer “subscriber services” via which individuals can gain access to customized information and guidance as needed. Employment modes are in essence “market segments.”

Several possible Employment Modes that can be employed in preferred embodiments are as follows:

“Stay in the Game” is a mode in which an employer gains experienced manager/executive and the employee remains in workforce yet at a slower trajectory. A user will select this mode if they possess industry/institutional knowledge, a technical skill set and/or broad management/business competencies. Typically this mode will focus on upper & middle management employees with 10+years of experience. An employee would select this mode if they recently changed lifestyle and were requesting less travel and flexible work scheduling. This mode would apply to segments like the baby boomer and sandwich generation.

“Back in the Game” is a mode via which an employer gains valuable skill set at a discount while the employee overcomes re-entry hurdle. This mode is geared to middle management roles, for employees possessing a technical skill set and/or basic management skills. From an employer perspective, this mode can accommodate budget limitations and from an employee perspective is for mid-level professionals who are job re-entrants, typically after a 2-7 year gap. This mode would apply to segments such as professional working mothers and the sandwich generation.

“High-Level Specialist” is a mode where an employer gains a highly seasoned executive and/or proven initiative manager, and taps into expertise without employee overhead costs. This mode applies best to employee transitions out of traditional full time but maintains viable role that could allow for recruiting for projects with tight scope and/or limited duration, or for enterprise initiatives. The employees in this mode have experience & a specific skill set that is transferable across industries and would fall into the category of upper management, e.g., with 10+years of specialized experience. This mode fits individuals that desire job scope in alignment with a personal lifestyle choice. This mode would apply to segments such as professional working mother, sandwich generation, baby boomer, and retirees.

“New Directions” is a mode where the employer gains an experienced manager with an innovative mindset, and the employee is “starting over.” This mode is directed toward those who are leveraging skills and experience and wish to tap into leadership & entrepreneurship traits. The employee will possess pragmatic business skills, broad management experience up to and including executive level individuals seeking industry change or former entrepreneurs entering corporate roles. This mode would apply to segments such as baby boomers, professional working mothers and retirees.

“Return of the Retiree” is a mode where the employer gains experienced professional and taps into a skill set at a reduced salary in exchange for benefits & flexibility. The employee has viable part time employment plus access to health coverage. This mode is applicable to employees with industry or institutional knowledge, a broad range of management skills, but for budget limitations fall into middle to upper level individuals that are seeking part-time employment and can trade salary level for benefits & flexibility. This mode would apply to segments such as age 55+ and professional.

“Get in the Game” is a mode where the employer attracts college graduates or other persons with specialized skill sets that are entering the workforce. In many instances, even young employees wish for lifestyle or personal reasons to have a flexible job, while employers often overlook flexibility in lower echelon positions which although entry level, require talent, education, skills and energy. This mode is applicable to those individual who are seeking entry level through upper level positions and to employees in segments such as “Generation Y” who have specific talents that are difficult to attract.

Individuals can thus navigate the site based on their stage of life and “work intention” and gain insight about their needs. “Employment modes” allow individuals to self-identify (e.g., as “Back in the Game”—professionals looking to return to work after off-ramping) helping the organization understand and access or retain “hidden talent”—professionals often not reached through traditional means. In another aspect, the individuals who use the systems of the represent invention will form a cohort or community amongst themselves created by their common goal of creating a flexible employment relationship. These individuals can self-assemble into communities that exchange information and share stories of success or otherwise. The modes described above will thus be further relevant as community identifiers. As explained above, these modes represent an individual's “work intention” and help the organization gain insight about them. Individual profiles from interested job candidates will be indexed by employment mode, industry, geographic region, and job type and flexibility arrangement. For employers this aspect of the present invention tailors online offerings to particular market segments via the employment modes. Jobseekers can review available positions within a particular profile that represent a range of work arrangements that match business productivity requirements with a professional's flexibility requirements. These modes represent a candidate's “work intention” and companies can leverage these modes to gain insight about these candidates upfront in the hiring process and leverage this data to “right-size” their organization based on their real time needs. These modes also give companies access to a tremendous talent pool that is not currently “found” through traditional on and off line recruiting sources. Finally, these modes will serve as key tools for a company's retention efforts as they can be modularized for an intranet platform.

Additionally, the present invention will offer traditional on-line search methods via geography, industry, salary etc. However, it is preferred that the job postings are indexed by employment mode, industry, geographic region, job type and flexibility arrangement, in addition to the customary input fields used to create a profile and submit a resume.

In preferred embodiments, a website made in accordance with the present invention will act as a destination for “alternative work arrangements.” For individuals evaluating opportunities to identify specific jobs as traditional or flexible, or both. The “Flex-It” designation for use internally or externally will allow members to earmark selected positions as flexibly inclined, or appropriate for flexible arrangements. When viewing postings on other job boards, candidates will be provided the option to “Flex-It” by pressing a button (typically a hypertext link) to connect them to the present invention and display the same job position in its flexible mode. Via the “Flex-It Button” companies can utilize the present invention as its sole outlet for posting flexible opportunities for one year. These jobs may be posted on mass job boards (e.g., Monster.com, Career Builder) as long as each job is accompanied by the present invention “Flex-It” designation. This will automatically brand a company's flexible/flexibly inclined jobs in the marketplace and further its diversity and inclusion branding efforts. Additionally, the “Flex-It” designation will allow a company to earmark selected positions, either internally or externally, as flexibly inclined, or appropriate for flexible arrangements. In certain embodiments this feature is enhanced by a resume filter to sort through resumes prior to forwarding them to a corporate human resources department. As a result, companies will receive qualified candidates only. The “Flex It” feature can also be descried as a “Flex-Me” button when activated or implemented by an employee or potential employee. In many instances, a job candidate, although seeking a full time traditional job may be inclined to consider flexible arrangements. In other ceases the candidate may only be seeking flexible arrangements. Typically these individuals will be agreeable to positions that carry lesser salary in exchange for a better lifestyle or other positive aspects of flexible employment.

Other features that could be included in certain embodiments of the present invention include a manager and supervisor forum that provides an information exchange for human resources representatives to share best practices with colleagues. Additionally, this feature provides information for employers to set up work-life programs and day-to-day implementation support. The website can also provide employee and employer advice on how to handle day-to-day workplace issues and a resource center that includes a listing of available information via books, websites, organizations that can assist site visitors in dealing with critical life issues—e.g., elder care.

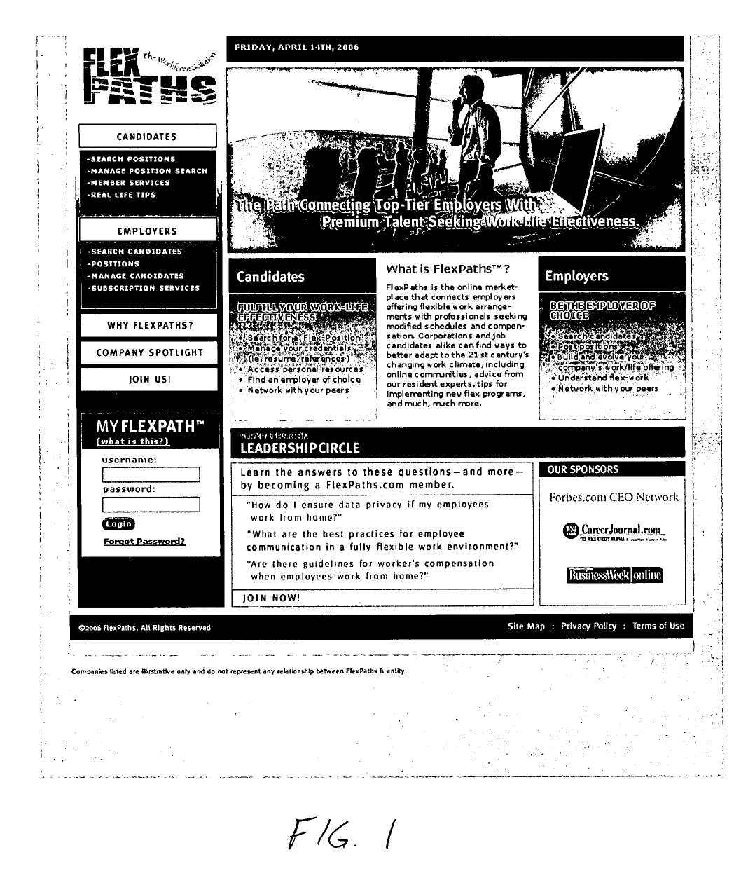

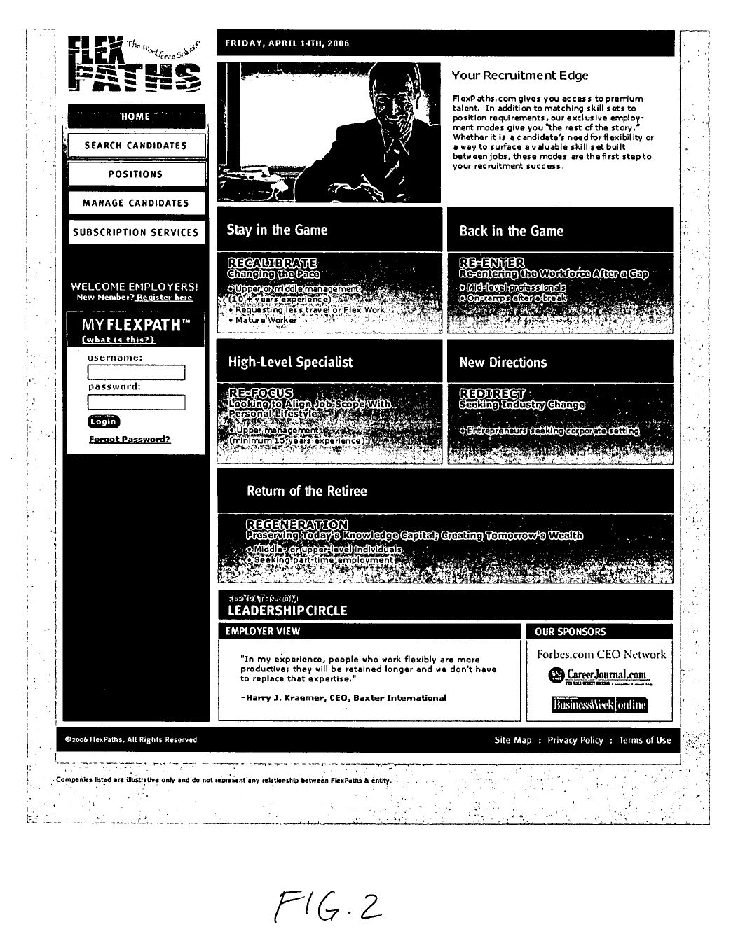

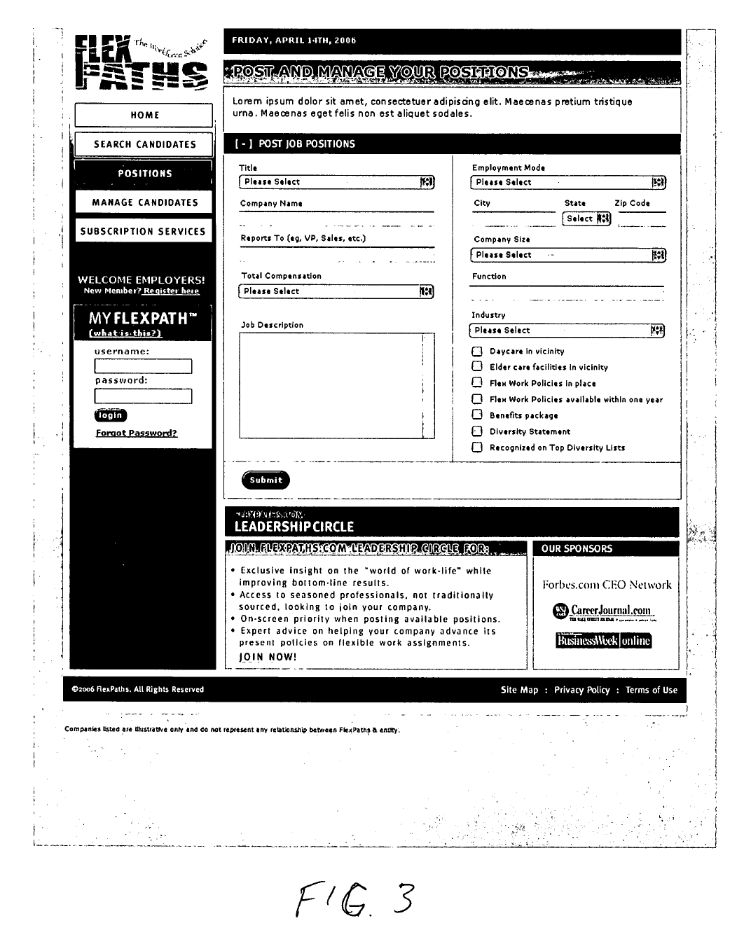

Referring now to FIGS. 1-3, illustrative examples of websites made in accordance with the present invention are illustrated. In FIG. 1 a screen shot is shown for an embodiment of the present invention that includes both a “Candidates” and an “Employers” section, and is password protected in terms of protecting personal information or making available subscription-based services. FIG. 2 is a screen shot illustrating the “employment modes” discussed above and also illustrating other features relevant to employers such as position and candidate management and links to general information about job flexibility. FIG. 2 is a screen shot also illustrating features relevant to employers such as the data entry screens and drop down boxes known in the art for data entry. A series of checkboxes permit an employer to self-describe and assess its flexibility profile, and as explained above, a similar scheme for the employee permits the data collected from the potential applicant and the employer to be processed and correlated to match the applicant with the employment position.

While preferred embodiments of the present invention have been described, additional variations and modifications in those embodiments may occur to those skilled in the art once they learn of the basic inventive concepts. Therefore, it is intended that the appended claims shall be construed to include all such variations and modifications as fall within the spirit and scope of the invention.

What is claimed is:

1. A method of managing employment between an employer and one or more applicants, comprising steps of:
providing job information pertaining to an employment position that needs to be filled, wherein said information comprises data relating to the flexibility of the employment position;
providing access to said job information to one or more potential applicants;
determining a correlation between one or more of said applicants and said job information; and
reporting information identifying the applicants and the correlation between the applicants and the job information.

2. The method according to claim 1, wherein the step of providing job information placing said information on a website.

3. The method according to claim 2, wherein the website requires registration and use of a password.

4. The method according to claim 3, wherein the step of registration requires payment of a subscription fee.

5. The method according to claim 1, wherein the data relating to flexibility comprises data related to the hours, benefits, schedule and location of the employment position.

6. The method of claim 5, wherein the data relating to flexibility is categorized into one or more employment mode categories.

7. The method according to claim 6, wherein the employment mode categories include data relating to acceptable experience levels, time out of the workforce and lifestyle data.

8. The method according to claim 6, wherein the employment mode categories are self-selected by an applicant from a fixed menu of choices.

9. The method according to claim 1, further comprising the step of collecting flexibility data concerning the correlation and rate of fulfillment of employment positions and analyzing the data to determine a statistical measure of job flexibility within a single organization.

10. The method according to claim 9, wherein the flexibility data are collected for a plurality of organizations and an objective flexibility index is determined to benchmark an organization against a standard.

11. A method of providing flexible employment in an organization to one or more applicants comprising the steps of:
providing job information pertaining to an employment position that needs to be filled, wherein said information comprises data relating to the flexibility of the employment position;
providing access to said job information to one or more potential applicants;
determining a correlation between one or more of said applicants and said job information; and
reporting information identifying the applicants and the correlation between the applicants and the job information.

12. The method according to claim 11, wherein said applicants are existing employees of the organization.

13. The method according to claim 11, wherein said applicants are individuals not employed the organization.

14. The method according to claim 11, further comprising the step of providing information about flexible employment relevant to one or more of employees and employers.

15. The method of claim 11, wherein the data relating to flexibility is categorized into one or more employment mode categories.

16. The method according to claim 15, wherein the employment mode categories include data relating to acceptable experience levels, time out of the workforce and lifestyle data.

17. The method according to claim 15, wherein the employment mode categories are self-selected by an applicant from a fixed menu of choices.

18. The method according to claim 11, further comprising the step of collecting flexibility data concerning the correlation and rate of fulfillment of employment positions and analyzing the data to determine a statistical measure of job flexibility within a single organization.

19. The method according to claim 18, wherein the flexibility data are collected for a plurality of organizations and an objective flexibility index is determined to benchmark an organization against a standard. 16. The method according to claim 11.

20. A website for managing employment between an employer and one or more applicants, comprising:
a system for providing job information pertaining to an employment position that needs to be filled, wherein said information selectively comprises data relating to the flexibility of the employment position enabled by activating a specific portion of said website to enable the processing of data pertaining to flexibility;
access to said job information to one or more potential applicants;
a system to create and display a correlation between one or more of said applicants and said job information; and
a system to report information identifying the applicants and the correlation between the applicants and the job information.
